(19) United States
(12) Patent Application Publication
(10) Pub. No.: US 2009/0314582 A1
(43) Pub. Date: Dec. 24, 2009

(54) Fork of a lifting device

(75) Inventor: Hendrik Meijer, St. Jacobiparochie (NL)

Correspondence Address: THE WEBB LAW FIRM, P.C., 700 KOPPERS BUILDING, 436 SEVENTH AVENUE, PITTSBURGH, PA, 15219, US

(73) Assignee: GEBR. MEIJER ST. JABIK B.V., St. Jacobiparochie (NL)

(21) Appl. No.: 11/921,277

(22) PCT Filed: May 26, 2006
(86) PCT No.: PCT/NL2006/000268

§ 371 Date: Aug. 5, 2009

(30) Foreign Application Priority Data
May 31, 2005 (NL) 1029152
Dec. 23, 2005 (NL) 1030776

(51) Int. Cl. B66F 9/12

(52) U.S. Cl. 187/237

(57) ABSTRACT

The invention relates to a fork of a lifting device, such as a forklift truck. The fork comprises a carrier part with a proximal side where the carrier part is connected to the lifting device in the situation of use, and a distal side which is remote from the lifting device in the situation of use. The fork also comprises a sliding part which is displaceable in a direction running between the proximal side and the distal side, and which sliding part is connected to the carrier part. The fork also comprises a drive between the carrier part and the sliding part for selectively lengthening and/or shortening the fork, wherein the drive comprises an electric motor and the transmission comprises a slip coupling.

The present invention relates to a fork of a lifting device, such as a forklift truck, and to a lifting device per se equipped with such a fork.

Forks for lifting devices are generally known, also with a property such that these forks can be extended. In the relevant technical field these forks are also known as reach forks. It is hereby possible to pick up and transport a load a greater distance from a lifting device. Such a fork and lifting device, such as are known, comprise: a carrier part with a proximal side where the carrier part is connected to the lifting device in the situation of use, and a distal side which is remote from the lifting device in the situation of use; a sliding part which is displaceable in a direction running between the proximal side and the distal side, wherein the direction of displacement is associated with the longitudinal direction of the carrier part; and a drive. The drive is used to bring about the displacement of the sliding part relative to the carrier part. The fork can thus be selectively lengthened or shortened.

It has been usual in the known art to make use of a hydraulic or pneumatic drive. There is however a discernible tendency to equip such lifting devices, in particular forklift trucks, increasingly more often with an electrical system particularly for displacing such a forklift truck. Problems occur here with the driving of the so-called reach forks.

The present invention is intended to provide a solution to this problem in new and inventive manner. For this purpose a fork, and therefore also a lifting device, is distinguished in that the drive comprises an electric motor. With an electric motor use can be made of a different energy source, in particular an electric battery, instead of a hydraulic or pneumatic system. Lifting devices, and in particular forklift trucks, with an electric motor for driving and propulsion thereof can thus also be equipped with reach forks.

According to the invention the transmission comprises a slip coupling. This is particularly advantageous in the sense that it is hereby possible to prevent the electric motor burning out or being overloaded. Such a situation can for instance occur when no measures are taken, such as providing a slip coupling, when a lifting device, or a forklift truck in particular, is standing with the forks against a wall or other obstacle and extension is desired, wherein the motor is set into motion. In order to prevent the motor being overloaded here, the slip coupling provides for a rotation or other movement of the electric motor without this necessarily being transmitted to the sliding part, thus realizing an effective fork safety.

This measure opens the door to a whole range of possibilities, options and further improvements, several of which are defined in non-limitative manner in the appended claims, in particular the dependent claims.

The drive preferably comprises a transmission, which can in particular be a planetary reduction gear. A suitable transmission ratio thus becomes possible in effective manner which enables the use of a relatively light electric motor. A light electric motor in particular can take a small form so that it need hardly take up any space in or at the fork, especially not where the thickness of the fork is concerned when the electric motor is incorporated in a fork. This is most recommended because normally a fork comprises in mounted position a vertically oriented component as well as a horizontally oriented component which normally serves as carrier part in the sense of the present invention. Incorporating of the electric motor in or at this carrier part can prevent the electric motor and the region of the fork where the electric motor must actually operate coming to lie a great distance from each other. In respect of the distance to be spanned for this purpose, the transmission can thus be kept short and bevel gears or similar components do not have to be used which are laborious and not very robust and which also take up space.

In a preferred embodiment a fork according to the present invention comprises a combination of a screw spindle connecting to the electric motor and a nut engaging the screw spindle. The motor (or the screw spindle connected thereto) and the nut are each connected respectively to a relevant carrier and sliding part. A sliding displacement of the sliding part relative to the carrier part can thus also actually be carried out.

In yet another preferred embodiment a fork according to the invention has the feature that the electric motor is arranged at a distance from the proximal side of the carrier part. The motor can thus be used without this causing weakening of the proximal side of the carrier part, particularly though not exclusively when there is arranged at this proximal side an extension which is a relevant factor in the suspending from a fork board, or directly from a mast or a forklift truck. Additionally or alternatively, the motors can of course also be controlled, in particular switched on and off, individually.

According to an embodiment of the invention, the fork comprises a blocking between the carrier part and the sliding part which is selectively energizable and in the energized state blocks movement of the sliding part relative to the carrier part. It has been found that, in some embodiments of a fork with an electric motor as drive, it is possible in some conditions for a sliding part to be pressed over or along the carrier part in undesirable manner without being driven by the drive. This happens because such a fork according to the invention then runs (extends and retracts) too smoothly. A blocking can provide a solution here for preventing this. The blocking can herein engage selectively on a drive element which is set into movement by the drive in an activated state of the drive. An undesired retracting and extending movement of the fork can be effectively prevented by blocking this drive element. In such an embodiment and with a screw spindle the drive element can comprise the nut. A very compact and simple configuration is thus realized. In an embodiment of the invention with a blocking, this blocking can further be of a normally energized type and, in an activated state of the drive, can enter into a mode which allows movements. The fork is thus always blocked, at least when the drive is not in operation or set into operation, and a high degree of reliability of the fork can be ensured in respect of the operation thereof.

An embodiment of a fork and of a lifting device incorporating a fork according to the present invention will be described hereinbelow on the basis of the added drawings. The drawings show a possible embodiment which, just as the dependent claims, must be deemed as non-limitative. In diverse views of different embodiments of the invention in the drawing the same or similar parts and components are designated with the same reference numerals. Further in the drawing:

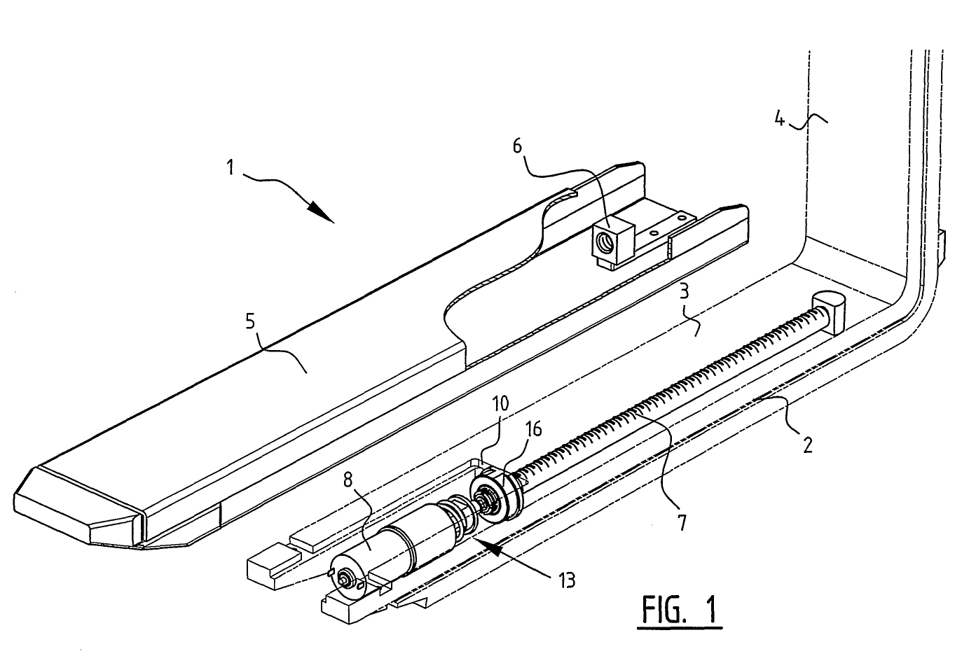

FIG. 1 shows an exploded perspective view of a fork according to the present invention;

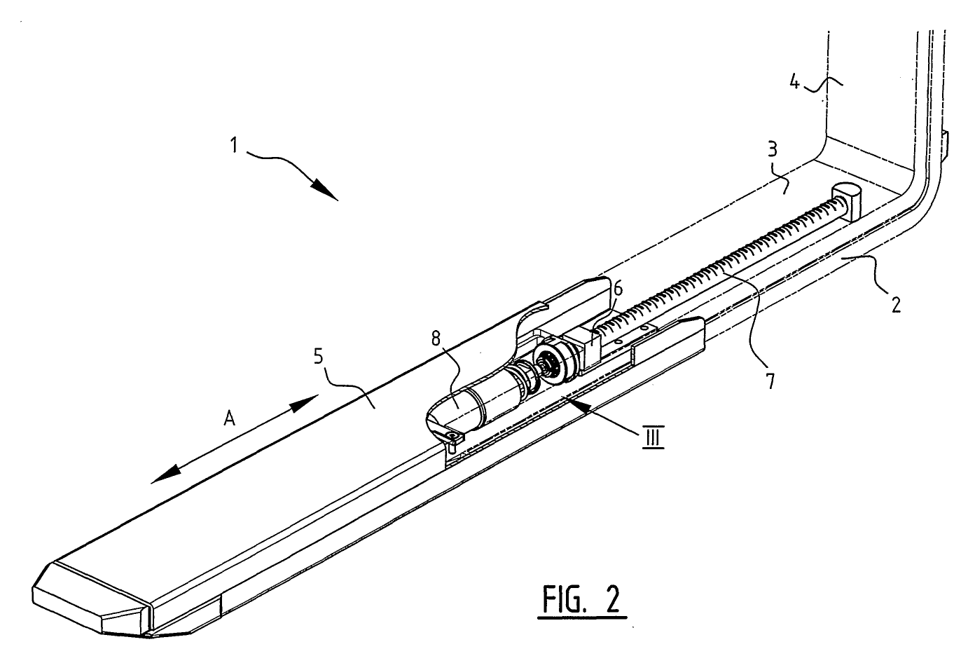

FIG. 2 is a partly cut-away perspective view of the fork of FIG. 1 in an operating state;

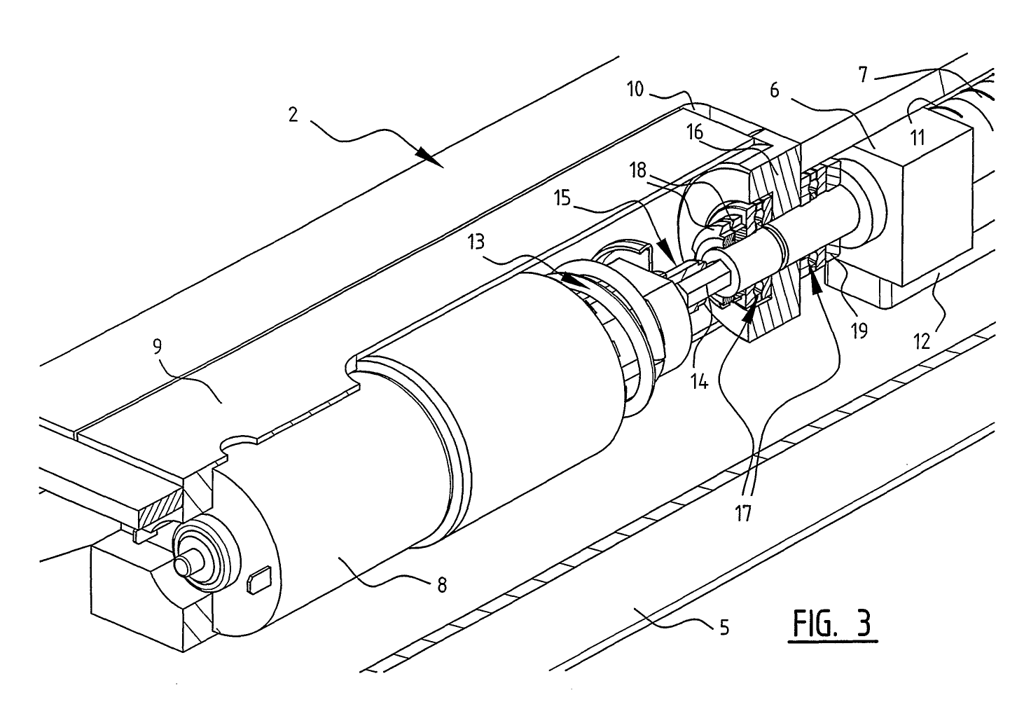

FIG. 3 is a detail of the fork according to the present invention shown in FIGS. 1 and 2;

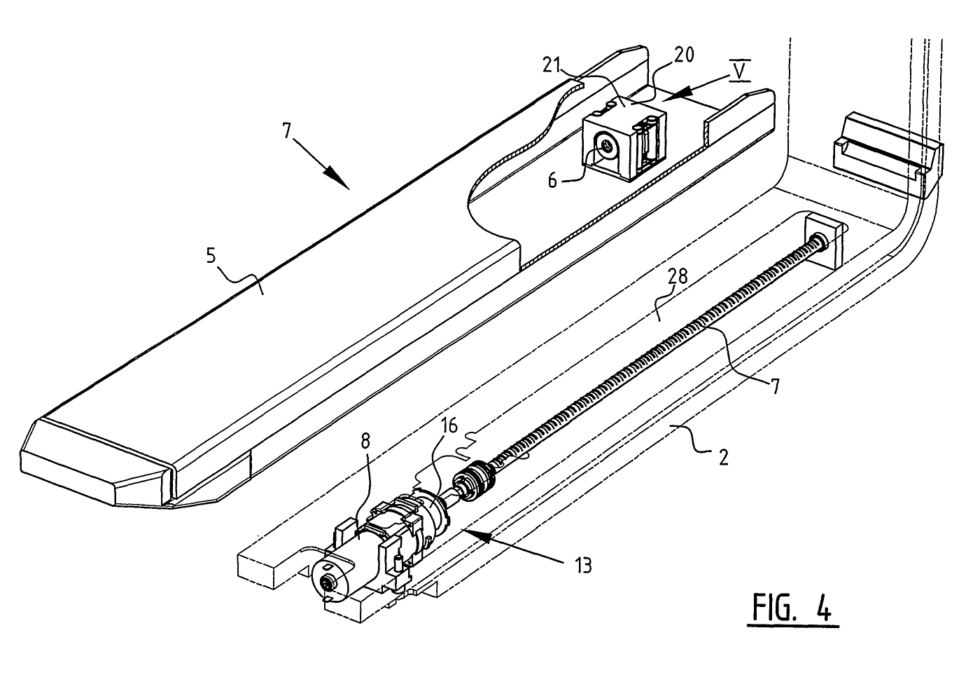

FIG. 4 is a view corresponding with FIG. 1 of an embodiment of a fork according to the invention with a blocking implemented therein;

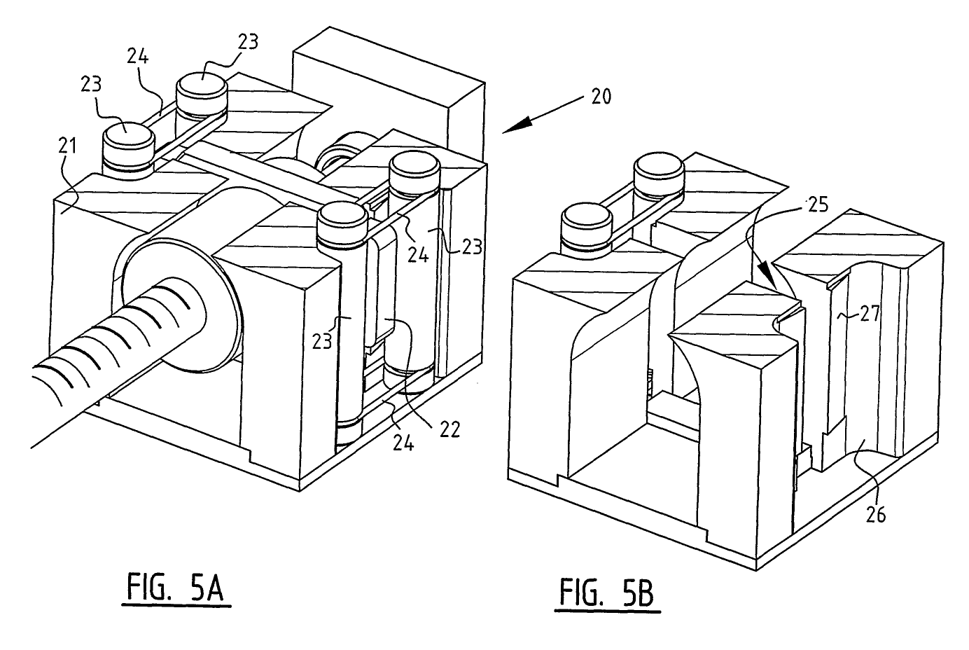

FIGS. 5A and 5B are perspective views of the blocking shown in FIG. 4; and

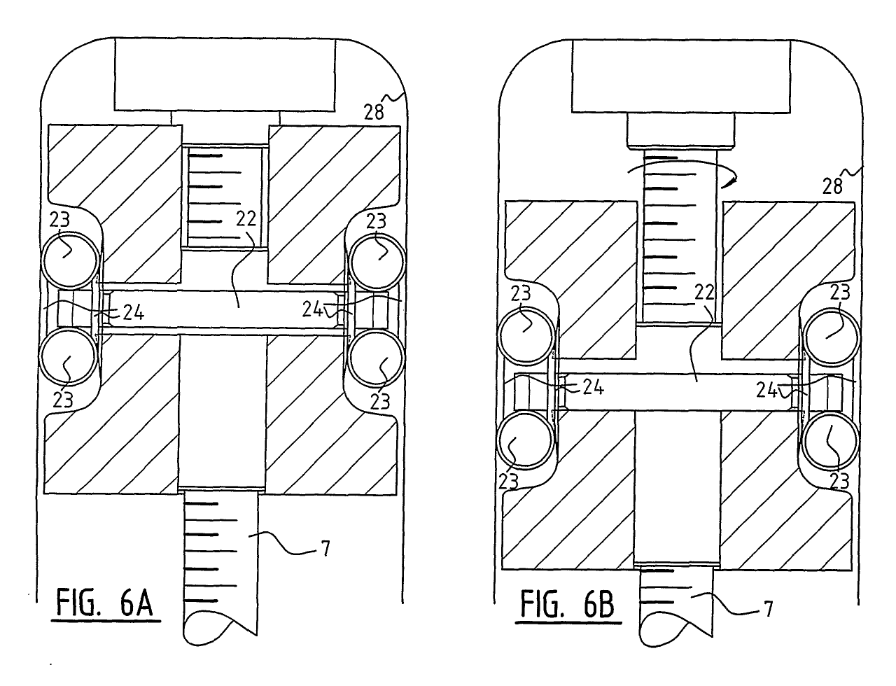

FIGS. 6A and 6B are top views of the blocking shown in FIG. 4 in two operational states thereof.

FIG. 1 shows a fork 1 as possible, non-limitative embodiment of the present invention. The fork is designated with reference numeral 1 and is also shown in operational, assembled state in FIG. 2.

Fork 1 comprises a carrier part 2 with a component 3 extending substantially in horizontal direction and a component 4 extending in substantially vertical direction.

Around and over the component 3 of carrier part 2 extending in horizontal direction fits a sliding part 5 which, as shown in FIG. 2, can perform a reciprocating movement in the direction of double arrow A. Sliding part 5 herein comprises in the interior thereof a nut 6 which engages a screw spindle 7 in the assembled position with carrier part 2. Screw spindle 7 extends in a recess in the component 3 of carrier part 2 extending in horizontal direction between a proximal side close to the component 4 extending in vertical direction and a distal side a distance from the component 4 extending in horizontal direction. Component 4 is intended for mounting on for instance a fork board of a forklift truck, so the terms distal and proximal must be interpreted in relation to the position of a driver of such a forklift truck who is situated on the driver's seat of this forklift truck. Screw spindle 7 thus extends from a region in the proximity of vertical component 4 of carrier part 2 to the free outer end of the component 3 of carrier part 2 extending in horizontal direction. Located at this position is an electric motor 8 with which sliding part 5 is reciprocally movable in the direction of double arrow A in FIG. 2.

FIG. 3 shows a more detailed view of the part of fork 1 according to the invention designated with III in FIG. 2.

In FIG. 3 is shown that motor 8 is placed in a housing 9 which is accommodated in an alcove 10 to which also connects the recess 11 in which screw spindle 7 is accommodated. Nut 6 is also arranged in recess 11 together with screw spindle 7, which nut 6 is movable in recess 11 in the direction of double arrow A in FIG. 2. Attached to the underside of nut 6 in FIG. 3 is a strip 12 which connects nut 6 to a sliding part 5 of fork 1. It is therefore the case that, when screw spindle 7 rotates about the longitudinal axis thereof due to the action of motor 8, nut 6 is displaced in the direction of double arrow A in FIG. 2, wherein sliding part 5 is co-displaced with nut 6 due to the mutual connection of these components to strip 12.

Further arranged between motor 8 and screw spindle 7 are several components serving for still further improved operation of fork 1 during retraction and extension thereof. A slip coupling 13 is thus provided connecting directly onto motor 8. As seen from motor 8, the slip coupling 13 is the first component in a sequence leading to screw spindle 7 for driving thereof. Slip coupling 13 ensures that electric motor 8 can rotate even if displacement or movement of sliding part 5 is blocked, so that electric motor 8 does not burn out in such a situation.

Slip coupling 13 also ensures that, in an application with two or more forks, the energizing of motors 8 can be initiated and ended simultaneously in each of the forks 1. If one of the motors 8 is faster than the other(s), for instance as a result of individual differences, the associated sliding part 5 will reach an extreme (retracted or extended) position in a shorter time than the other(s), although motor 8 remains energized with the other motor(s) 8 so that the other fork(s) also reach this same extreme position without the risk of the faster motor 8 burning out. A kind of synchronization or reset of sliding parts 5 of the forks is thus realized in the extreme positions thereof.

Screw spindle 7 has an outer end 14 with a hexagonal peripheral form on which engages a coupling 15 which is connected via slip coupling 13 to the motor.

Housing 9 of motor 8 further has an alignment 16 comprising two pressure bearings 17, wherein pressure bearings 17 are held in place by means of two locking nuts 18 on one side and a further locking nut 19 on the other. Locking nut 19 further also forms a stop for nut 6 for the purpose of defining an extreme displacement position or limit of movement of nut 6.

It is noted that it is advantageous to measure the actual displacement distance or even to have control of the fork take place on the basis thereof. A measuring system can be designed in a manner comparable to a linear potentiometer, particularly when a combination of a screw spindle 7 and a nut 6 is applied.

The electrical power supply to the motors can take place via cables running along the fork board, although alternatively batteries in or on the forks can also be applied. It is particularly possible to integrate or at least mount batteries in the vertical components 4 of forks.

FIG. 4 is a view similar to FIG. 1, though of another embodiment having in addition a blocking 20. This comprises a housing 21 which is fixed to the sliding part. Nut 6 is enclosed in housing 21, be it with a limited clearance, as shown in FIGS. 5 and 6.

In FIG. 5 of the housing is cut-away at the top so as to clearly show the nut 6 therein, as well as the other components. A plate 22 is arranged on nut 6, which plate extends laterally or radially relative to spindle 7. Plate 22 herein protrudes into the housing with clearance relative to a gap 25 between two shaft assemblies on either side of housing 21, wherein each of the shaft assemblies comprises two shafts 23 and the two shafts 23 in each of the shaft assemblies are mutually connected by means of an O-ring 24. The housing comprises in the side surfaces thereof recesses 26 for receiving shafts 23 therein, these shafts defining a surface 27 running outward in the direction of the gap.

FIGS. 6A and 6B show different operating modes of the blocking. FIG. 6A shows the rest position of the blocking. Spindle 7 is stationary. The shaft assemblies of shafts 23 are centered on plate 22 and in balance relative to the inclining surfaces 27. When spindle 7 then begins to rotate, plate 22 with nut 6 round spindle 7 then comes to lie in the position shown in FIG. 6B against a wall of housing 21 defining the gap. The lower of the shafts 23 in FIG. 6B of the two shaft assemblies in the drawing are herein pressed downward, and on this side of the housing jamming or blocking of the housing against an inner wall 28 (see FIG. 4) of carrier part 2 is ended or prevented. On the top side of the housing in the drawing the upper of the shafts 23 of the shaft assembly are not clamped between inner wall 28 and inclining surfaces 27, since the inclining surfaces co-displace at the same speed of movement with shafts 23. Thus is achieved that when spindle 7 is driven, and housing 21 thereby displaced, blocking 20 is taken out of operation.

Conversely, when a force is exerted on sliding part 5, this sliding part will tend to displace in the direction of the exerted force. This is undesirable, as this could cause damage to the motor 8. The blocking 21 is provided for this reason. When the sliding part tends to displace, housing 21 will thereby be co-displaced. Depending on the direction of movement in which sliding part 5, and thereby housing 21, will tend to start moving, the upper or the lower shafts 23 of the shaft assemblies on either side of the housing will herein become clamped in blocking manner between inclining surfaces 27 and inner wall 28 of carrier part 2. The blocking is active without driving almost immediately a movement begins, and is in fact always so unless the movement is driven by the drive, which provides for unblocking of blocking 21.

The housing of blocking 21 is mounted on sliding part 5. Spindle 7 is mounted in carrier part 2 of fork 1. Sliding part 5 is moved by the rotating movement of spindle 7. This ensures that nut 6, which is mounted in housing 21 of blocking 20, moves to the left and right and carries along the sliding part 5. If an outside force is then exerted on sliding part 5, housing 21 then moves and becomes immediately fixed because shafts 23 run up against an inclining surface 27. Blocking 20 is immediately active. When spindle 7 is now moved again, plate 22 on nut 6 ensures that shafts 23 are pressed out of the blocked position. The O-rings 24 ensure that when at rest shafts 23 are always pressed against inclining surfaces 27. Sliding part 5 is therefore always blocked unless it is unlocked and released for movement by plate 22 on nut 6 by movement of spindle 7.

After examination of the foregoing many alternative and additional embodiments will occur to the skilled person, all of which should be deemed as possibilities within the scope of protection of the present invention as according to the following claims, unless these embodiments depart from the letter or spirit of these claims. It is thus possible within the scope of the invention to make use of a sliding part which does not fit per se as a sleeve-like component round the carrier part, but only has to be arranged partially round the carrier part, particularly in order to save space in height direction of fork 1. A plurality of electric motors can also be provided, for instance one on each side of the horizontally oriented component of carrier part 2, to thus be able to produce greater forces. This will of course also affect the electric power supply which must be dimensioned such that a greater number of electric motors can be driven thereby. The configuration of the electric motor and the horizontal component 3 of sliding part 2 can of course also be reversed, wherein electric motor 3 can be situated in the vicinity of the component 4 of carrier part 2 extending in vertical direction. This does however require a modification of the production process which is more difficult to realize than the alcove 10 in the free outer end of carrier part 2 as shown for instance in FIG. 2 and FIG. 3.

1-15. (canceled)

16. A fork of a lifting device, such as a forklift truck, comprising:
a carrier part with a proximal side where the carrier part is connected to the lifting device in the situation of use, and a distal side which is remote from the lifting device in the situation of use;
a sliding part which is displaceable in a direction running between the proximal side and the distal side, and which sliding part is connected to the carrier part; and
a drive between the carrier part and the sliding part for selectively lengthening and/or shortening the fork, wherein the drive comprises an electric motor, and wherein the carrier part comprises between the proximal side and the distal side thereof a recess for receiving the electric motor therein.

17. The fork as claimed in claim 16, wherein the carrier part comprises on the proximal side thereof an extension on the proximal side thereof, for mounting on a lifting device, and wherein the electric motor is placed in or at the distal side of the carrier part or at least a distance from the extension.

18. The fork as claimed in claim 16, wherein the drive further comprises a transmission.

19. The fork as claimed in claim 18, wherein the transmission comprises a planetary reduction gear.

20. The fork as claimed in claim 18, wherein the transmission comprises a slip coupling.

21. The fork as claimed in claim 16, further comprising a combination of a screw spindle connected to the electric motor and a nut which engages the screw spindle and which is connected to one of the carrier part and the sliding part, and the motor is connected to the other.

22. The fork as claimed in claim 21, further comprising:
measuring and/or control means for measuring the degree of displacement of the sliding part relative to the carrier part and/or controlling the fork on the basis of this information.

23. The fork as claimed in claim 16, wherein the sliding part is telescopically displaceable relative to the carrier part.

24. The fork as claimed in claim 16, wherein the carrier part comprises on the proximal side thereof an extension at an angle relative to the part of the carrier part connected to the sliding part for the purpose of mounting on a lifting device.

25. The fork as claimed in claim 16, further comprising a blocking between the carrier part and the sliding part which is selectively energizable, and in the energized state blocks movement of the sliding part relative to the carrier part.

26. The fork as claimed in claim 25, wherein the blocking engages selectively on a drive element which is set into motion by the drive in an activated state of the drive.

27. The fork as claimed in claim 21, wherein the drive element comprises the nut.

28. The fork as claimed in claim 25, wherein the blocking is of a normally energized type and, in an activated state of the drive, enters into a mode which allows movements.

29. A lifting device, such as a forklift truck, which comprises at least a frame and at least one fork arranged on the frame, which fork comprises:
a carrier part with a proximal side where the carrier part is connected to the lifting device, and a distal side which is remote from the lifting device;
a sliding part which is connected to the carrier part for displacement in the direction between the proximal and distal sides; and
a drive between the carrier part and the sliding part for selectively lengthening and/or shortening the fork,
wherein the drive comprises an electric motor, and wherein the carrier part comprises between the proximal side and the distal side thereof a recess for receiving the electric motor therein.

30. The lifting device as claimed in claim 29 with a fork as claimed in claim 16.
